(19) United States
(12) Patent Application Publication
(10) Pub. No.: US 2025/0006980 A1
(43) Pub. Date: Jan. 2, 2025

(54) Electrolyte Formulation for Lithium-Ion Batteries

(71) Applicant: Nissan North America, Inc., Franklin, TN (US)

(72) Inventors: Balachandran Gadaguntla Radhakrishnan, Palo Alto, CA (US); Shigemasa Kuwata, Mountain View, CA (US); Somayeh Zamani, Novi, MI (US); Bharat Gattu, Farmington, MI (US); Dianne Atienza Hay, Hartland, MI (US); Simran Kumari, Los Angeles, CA (US)

(21) Appl. No.: 18/341,401

(22) Filed: Jun. 26, 2023

(51) Int. Cl. H01M 10/0525; H01M 4/38; H01M 4/583; H01M 10/0567; H01M 10/0568; H01M 10/0569

(52) U.S. Cl. CPC H01M 10/0525; H01M 4/386; H01M 4/583; H01M 10/0567; H01M 10/0568; H01M 10/0569; H01M 2004/027; H01M 2004/028; H01M 2300/0028; H01M 2300/0051

(57) ABSTRACT

A lithium-ion battery has anode active material, nickel-based cathode active material, and an electrolyte. The electrolyte has the following formulation: a carbonate-based solvent; LiPF₆; vinylene carbonate; and an additive that satisfies the following: less than or equal to nine carbons; at least one unsaturated bond; a predicted oxidation potential Vₒₓ of 2.0<Vₒₓ<4.5; and a boron atom, a phosphorus atom or an S—N functional.

### TECHNICAL FIELD

This disclosure relates to liquid electrolyte formulations for lithium-ion batteries having a functionalized additive for a stable cathode-electrolyte-interface (CEI).

### BACKGROUND

A conventional electrolyte formulation for a lithium-ion battery will include a lithium salt such as LiPF₆ and a carbonate-based solvent. When a small amount of water is naturally introduced to the battery, the water reacts with the salt, forming hydrogen fluoride, which reacts with the transition metals in the cathode active material. This is particularly pervasive when the cathode active material includes nickel. The nickel is pulled into the electrolyte, decreasing the cell capacity.

Although nickel-rich cathode active materials are of interest owing to their high specific capacities, nickel-rich cathode active material faces other challenges. It is challenging to stabilize the nickel-rich cathode interface over long-term cycling, due in part to parasitic reactions, including electrolyte permeation, which results in the growth of impedance and capacity decay.

### SUMMARY

Disclosed herein are implementations of lithium-ion batteries that incorporate one or more electrolyte additives that are specifically functionalized to organically create a physical barrier on the cathode surface. The physical barrier is a protective, uniform film that improves the interface stability, inhibits the decomposition of the electrolyte, inhibits the side reactions at the interface, scavenges hydrogen fluoride and/or water, with hydrogen fluoride quenching preferred, and oxidizes before the electrolyte solvents.

One implementation of a lithium-ion battery as disclosed has anode active material, nickel-based cathode active material, and an electrolyte. The electrolyte has the following formulation: a carbonate-based solvent; LiPF₆; vinylene carbonate; and an additive that satisfies the following: less than or equal to nine carbons; at least one unsaturated bond; a predicted oxidation potential Vₒₓ of 2.0<Vₒₓ<4.5; and a boron atom, a phosphorus atom or an S—N functional.

Another implementation of a lithium-ion battery as disclosed herein has anode active material, nickel-based cathode active material, and an electrolyte. The electrolyte has a solvent, a lithium salt, vinylene carbonate, and one or more additives. Each additive consists of: less than or equal to nine carbons; at least one unsaturated bond; a predicted oxidation potential Vₒₓ of 2.0<Vₒₓ<4.5; and atoms selected from the group consisting of: C; H; O; N; S; B; Br; F; and Cl.

Also disclosed is a liquid electrolyte for a lithium-ion battery, comprising one or more additives selected from the group consisting of:

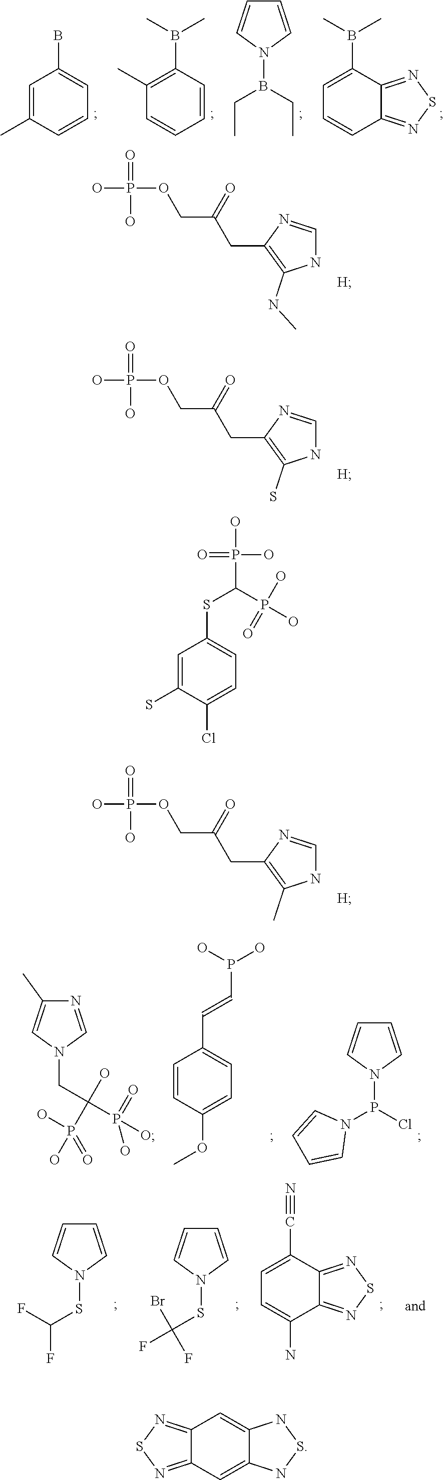

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic of a lithium-ion battery cell.

### DETAILED DESCRIPTION

A conventional electrolyte formulation for a lithium-ion battery will include a lithium salt such as LiPF₆ and a carbonate-based solvent. When a small amount of water is naturally introduced to the battery, the LiPF₆ may undergo a series of side reactions:

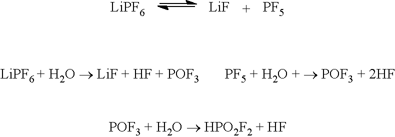

The hydrogen fluoride reacts with the cathode active material, releasing the transition metals into the electrolyte. Additives that scavenge hydrogen fluoride alone do not eliminate the problem, but rather try to reduce the hydrogen fluoride's negative impact.

High energy batteries will increasingly depend on layered oxides, with the amount of nickel in the layered oxides growing. Due to the cost and depleting reserves of cobalt, cathode active materials with diminished mole ratios of cobalt, or no cobalt altogether, have been developed. Nickel-rich NMC cathode active materials often have the formula LiNiₓM₁₋ₓO₂, where x≥0.6 and M=Mn, Co, and sometimes Al. Manganese and aluminum are essentially inactive, providing stability to the properties of the battery. The more nickel used, the greater the amount of lithium that can be cycled in and out of the cathode.

However, nickel-rich cathode active materials face challenges. Nickel-rich cathode active materials are particularly susceptible to the hydrogen fluoride scavenging, resulting in dramatically decreased cell capacity. It is challenging to stabilize the nickel-rich cathode interface over long-term cycling, due in part to parasitic reactions, including electrolyte permeation, which results in the growth of impedance and capacity decay. Providing a stable CEI interface can suppress the electrolyte decomposition, improve the interface stability, and alleviate transition metal ion dissolution.

There are conventional electrolyte additives that are used to address one or more of these issues. Often, multiple additives are used in a formulation, each selected for a particular role but having a limited impact. With each cathode additive needed in the formulation, issues with compatibility with the other electrolyte components such as solvents and anode additives, as well as compatibility with the anode material, may present a new set of problems.

The electrolyte formulations disclosed herein contain an electrolyte additive specifically functionalized to organically create a physical barrier on the cathode surface. The physical barrier is a protective, uniform film that improves the interface stability, inhibits the decomposition of the electrolyte, inhibits the side reactions at the interface, scavenges hydrogen fluoride and/or water, with hydrogen fluoride quenching preferred, and oxidizes before the electrolyte solvents.

The disclosed electrolyte additives are specifically formulated to improve the performance of nickel-based cathode active materials. Nickel-based cathode active materials include, but are not limited to, LiNiO₂, Li(Ni_{0.5}Mn_{0.5})O₂, LiNiₓCo_{y}Mn_{z}O₂, LiNi_{0.5}Co_{0.5}PO₄, and LiNi_{0.8}Co_{0.15}Al_{0.05}O₂. The nickel-based cathode active material can have the formula LiNiₓM₁₋ₓO₂, where x≥0.6, and more particularly x≥0.8, and M=Mn, Co, and Al. As needed, the cathode active material can contain an electroconductive material, a binder, etc.

The disclosed electrolyte additives are also specifically formulated for lithium-ion batteries having an anode active material that is graphite or an anode active material that is a silicon-based material. The silicon-based material is not limited except to include some form of silicon or silicon alloy. Non-limiting examples of silicon-based anode material include Si, SiOx, and Si/SiOx composites. A conducting agent may be used. Further, one or more of a binder and a solvent may be used to prepare a slurry that is applied to a current collector, for example.

The electrolytes disclosed herein have the following formulation: a solvent; a lithium salt; vinylene carbonate (VC); and an additive that satisfies the following: less than or equal to nine carbons; at least one unsaturated bond; a predicted oxidation potential Vₒₓ of 2.0<Vₒₓ<4.5; and a boron atom, a phosphorus atom or an S—N functional. The additive will have one of the boron atom, phosphorus atom or S—N functional, but may also have more than one of these. The additive will only have atoms selected from the group consisting of: C; H; O; N; S; B; Br; F; and Cl.

The term “formulation” as used herein indicates that the formulation consists of the named components. However, it is contemplated herein that the electrolytes disclosed herein may comprise additional components.

The electrolyte additives are formulated to work with a carbonate-based solvent and lithium hexafluorophosphate (LiPF₆) as the lithium salt. In particular, the carbonate-based solvent can be one or more of ethylene carbonate (EC), diethyl carbonate (DEC), and fluoroethylene carbonate (FEC). The LiPF₆ has a molar concentration of 0.5M to 3.0M.

The electrolyte additives disclosed herein have also been found to create the physical CEI barrier when used with one or both of dioxolane (DOL) and dimethoxyethane (DME) with one or both of lithium bis(fluorosulfonyl)imide (LiFSI) and lithium bis(trifluoromethanesulfonyl)imide (LiTFSI). The total lithium salt has a molar concentration of 0.5M to 3.0M.

The electrolyte additive or additives are between 0.1 wt % and 10.0 wt % of the total electrolyte, and more particularly between 0.5 wt % and 5.0 wt % of the total electrolyte.

The electrolyte additives disclosed herein work with the VC, an anode-directed additive, to enhance the durability of the battery while operating in a voltage range of 2.0 V to 5.0 V. The VC can be 0.5 wt % to 3.0 wt % of the electrolyte. VC has been shown to have a positive impact on the capacity retention and coulombic efficiency of anodes in lithium-ion batteries, particularly with silicon-based anode active material.

The electrolyte additives disclosed herein have a predicted oxidation potential of between 2.0 and 4.5, which falls within the typical battery operating voltage range. The electrolyte additives oxidize in the operating voltage range, with the oxidation products participating in the CEI formation. The electrolyte additives may have a lower oxidation potential than the electrolyte as a whole.

The one or more unsaturated bonds in the electrolyte additives initiate the polymerization reactions, which form the cathode protective layer, or CEI. The polymerization reactions start before the decomposition of the electrolyte/salt, forming the protective barrier before the electrolyte can decompose and be detrimental to the cathode active material.

The boron and phosphorus atoms are electron donors that may also initiate the polymerization reactions which form the cathode protective layer, or CEI. The S—N functional bonds preferentially react with hydrogen fluoride, scavenging the hydrogen fluoride.

The electrolytes with the electrolyte additive formulations disclosed herein form a CEI during the first few cycles (i.e., less than 10) of the battery that is between 1 nm and 100 nm with very poor electron conductivity (i.e., less than 10⁻⁹ mS/cm). The CEI formed from polymerization of the electrolyte additives allows lithium ion penetration while preventing nickel dissolution and electrolyte oxidation. Hydrogen fluoride and/or water is scavenged, preventing HF attack.

Table 1 is a list of electrolyte additives.

TABLE 1

| | | Predicted Oxidation | |
|---|---|---|---|
| Molecule | Formula | Potential | |
| 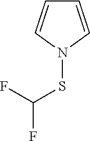 | C₅H₅SNF₂ | 4.28 | S—N functional |
| 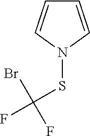 | C₅H₄SBrNF2 | 4.44 | S—N functional |
| 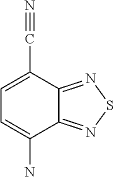 [SMILES: N#Cc1ccc(N)c2nsnc12] | C₇H₄SN4 | 4.32 | S—N functional |
| 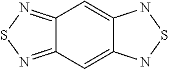 [SMILES: c1c2c(cc3nsnc13)NSN2] | C₆H₂S₂N₄ | 4.45 | S—N functional |
| 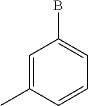 | C₇H₇B | 3.72 | B atom |
| 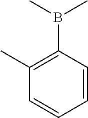 | C₉H₁₃B | 4.47 | B atom |
| 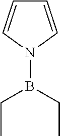 | C₈H₁₄BN | 4.10 | B atom |
| 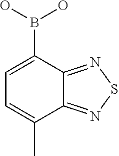 | C₇H₇BSNO₂ | 4.48 | B atom |
| 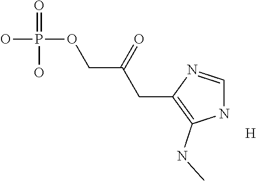 | C₇H₁₂PN₃O₅ | 3.73 | P atom |
| 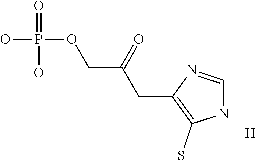 | C₆H₉PSN₂O₅ | 4.05 | P atom |
| 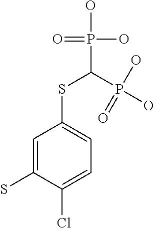 [SMILES: O=P(O)(O)C(Sc1ccc(Cl)c(S)c1)P(=O)(O)O] | C₇H₉P₂S₂ClO₆ | 4.49 | P atom |
| 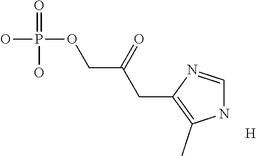 | C₇H₁₁PN₂O₅ | 3.61 | P atom |
| 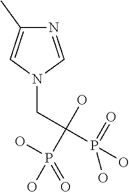 [SMILES: Cc1cn(CC(O)(P(=O)(O)O)P(=O)(O)O)cn1] | C₆H₁₂P₂N₂O₇ | 4.26 | P atom |
| 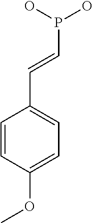 | C₉H₁₁PO₃ | 4.04 | P atom |
| 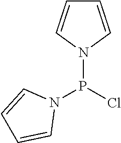 [SMILES: ClP(n1cccc1)n1cccc1] | C₈H₈PN₂Cl | 4.25 | P atom |

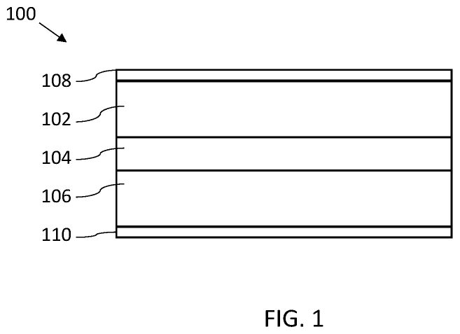

A lithium-ion battery cell 100 is illustrated schematically in cross-section in FIG. 1. The lithium-ion battery cell 100 of FIG. 1 is configured as a layered battery cell that includes as active layers a cathode active material layer 102, an electrolyte 104 as disclosed herein, and an anode active material layer 106. The lithium-ion battery cell 100 may include a separator interposed between the cathode active material layer 102 and the anode active material layer 106. In addition to the active layers, the lithium-ion battery cell 100 of FIG. 1 may include a cathode current collector 108 and an anode current collector 110, configured such that the active layers are interposed between the anode current collector 110 and the cathode current collector 108. In such a configuration, the cathode current collector 108 is adjacent to the cathode composite layer 102, and the anode current collector 110 is adjacent to the anode active material layer 106. A lithium-ion battery can be comprised of multiple lithium battery cells 100.

The cathode current collector 108 can be, for example, an aluminum sheet or foil. The anode current collector 110 can be a copper or nickel sheet or foil, as a non-limiting example. Examples of the separator are porous films of polyolefin such as polyethylene and polypropylene.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A lithium-ion battery, comprising:
anode active material;
nickel-based cathode active material; and
an electrolyte having a formulation as follows:
a carbonate-based solvent;
LiPF₆;
vinylene carbonate; and
an additive that satisfies the following:
less than or equal to nine carbons;
at least one unsaturated bond;
a predicted oxidation potential Vₒₓ of 2.0<Vₒₓ<4.5; and
a boron atom, a phosphorus atom or an S—N functional.

2. The lithium-ion battery of claim 1, wherein the nickel-based cathode active material has a nickel content of greater than 80%.

3. The lithium-ion battery of claim 1, wherein the additive has the boron atom and is:

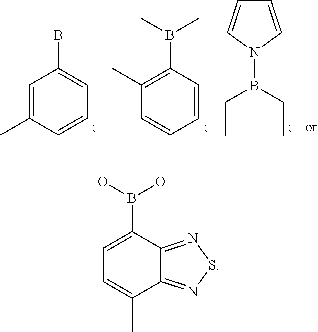

4. The lithium-ion battery of claim 1, wherein the additive has the phosphorus atom and is:

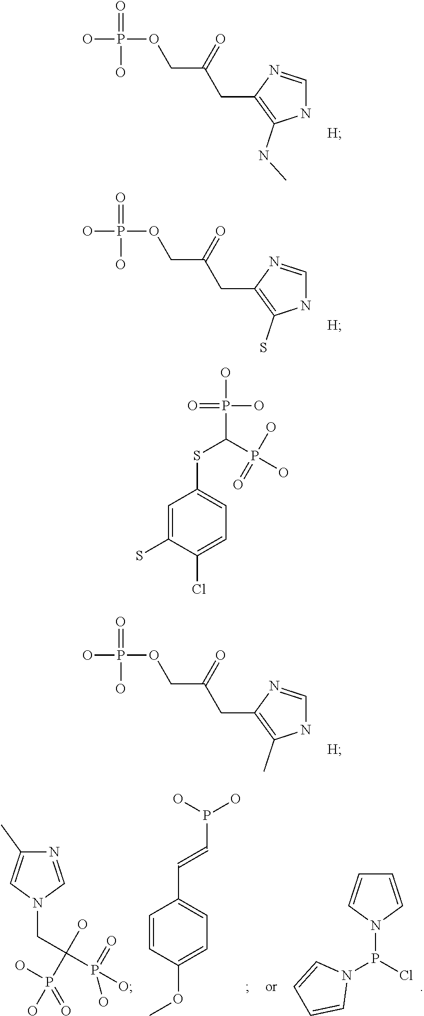

5. The lithium-ion battery of claim 1, wherein the additive has the S—N function and is:

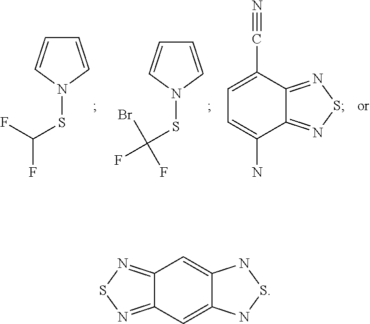

6. The lithium-ion battery of claim 1, wherein the anode active material is graphite.

7. The lithium-ion battery of claim 1, wherein the anode active material is a silicon-based material.

8. A lithium-ion battery, comprising:
anode active material;
nickel-based cathode active material; and
an electrolyte comprising:
a solvent;
a lithium salt;
vinylene carbonate; and
one or more additives, each additive consisting of:
less than or equal to nine carbons;
at least one unsaturated bond;
a predicted oxidation potential Vₒₓ of 2.0<Vₒₓ<4.5; and
atoms selected from the group consisting of: C; H; O; N; S; B; Br, F; and Cl.

9. The lithium-ion battery of claim 8, wherein the solvent is one or more of ethylene carbonate, diethyl carbonate and fluoroethylene carbonate and the lithium salt is LiPF₆.

10. The lithium-ion battery of claim 8, wherein the solvent is one or both of dioxolane and dimethoxyethane and the lithium salt is one or both of LiTFSI and LiFSI.

11. The lithium-ion battery of claim 8, wherein the nickel-based cathode active material has a nickel content of greater than 80%.

12. The lithium-ion battery of claim 8, wherein the vinylene carbonate is 0.5 wt % to 3.0 wt % of the electrolyte.

13. The lithium-ion battery of claim 8, wherein one of the one or more additives is:

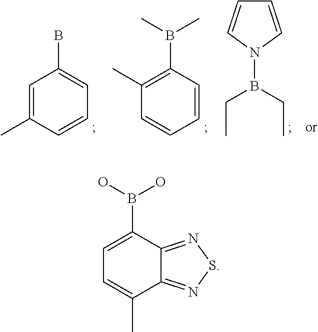

14. The lithium-ion battery of claim 8, wherein one of the one or more additives is:

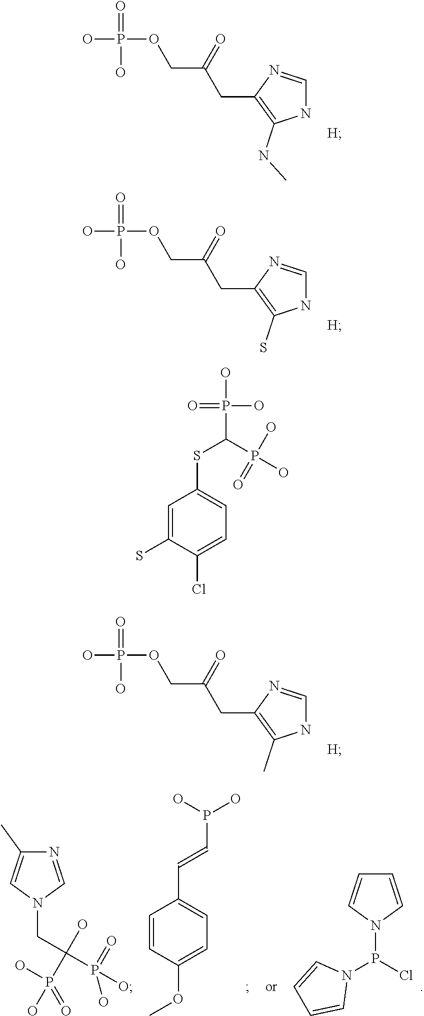

15. The lithium-ion battery of claim 8, wherein one of the one or more additives is:

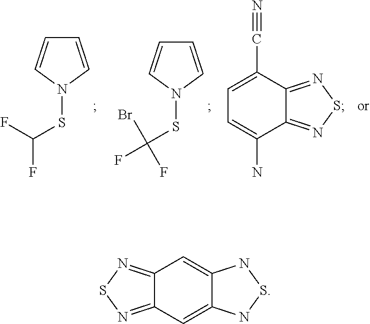

16. The lithium-ion battery of claim 8, wherein the anode active material is graphite.

17. The lithium-ion battery of claim 8, wherein the anode active material is a silicon-based material.

18. A liquid electrolyte for a lithium-ion battery, comprising:
one or more additives selected from the group consisting of: [chemical structure]
